(19) United States
(12) Patent Application Publication
(10) Pub. No.: US 2013/0128325 A1
(43) Pub. Date: May 23, 2013

(54) PROCESS FOR OBTAINING A VARIABLE HIGH SECURITY HOLOGRAM AND ITS APPLICATIONS

(71) Applicant: Rafael Artasanchez Bautista, Colonia Anahuac (MX)

(72) Inventor: Rafael Artasanchez Bautista, Colonia Anahuac (MX)

(21) Appl. No.: 13/516,572

(22) PCT Filed: Dec. 15, 2010
(86) PCT No.: PCT/IB10/03398

§ 371 Date: Feb. 8, 2013

(30) Foreign Application Priority Data
Dec. 16, 2009 (MX) MX/A/2009/014021
Aug. 16, 2010 (MX) MX/A/2010/009013

(51) Int. Cl. G03H 1/00; G03H 1/04

(52) U.S. Cl. CPC G03H 1/0011; G03H 1/0476
USPC 359/2; 347/110

(57) ABSTRACT

The invention relates to the generation of serialized or variable security holograms on labels, stamps, forms, packaging, etc., and the process by which they are obtained to prevent frauds, adulterations and counterfeits of official documents, securities, lottery tickets, certificates, tax stamps, diplomas, show tickets, all kinds of identifications, insurances, and in general all kinds of items or official papers, as well as for the efficient administration and control of applications and solutions.

### CROSS-REFERENCE TO RELATED APPLICATIONS

This application is a national phase of International Application No. PCT/IB2010/003398, filed Dec. 15, 2010, which claims priority to Mexico Application No. MX/A/2009/014021, filed Dec. 16, 2009, the entireties of which applications are herein incorporated by reference.

### FIELD OF THE INVENTION

The invention relates to the creation of variable holograms which are used to prevent frauds, adulterations and counterfeits of official documents, securities, lottery tickets, certificates, tax stamps, diplomas, show tickets, identifications of all kinds, insurances, and in general all official and/or confidential documents and items, as well as the efficient administration and control of applications or solutions and the manner in which they are obtained.

### BACKGROUND

There is a constantly growing need in the world for elements to prevent counterfeiting and fraud. Counterfeits and adulterations are made of a wide variety of articles, including drugs, food products, alcoholic beverages, apparel, shoes, software, audio recordings, video recordings, spare parts, etc.

Anti-counterfeiting elements to prevent counterfeiting should be effective as well as easily recognizable and identifiable by the consumer and the authority, using a technology which prevents the creation of imitations and illegal copies. This barrier can be achieved through the permanent development of high technology systems that are not within the range of the common counterfeiter.

Holograms can be used as an anti-counterfeiting measure. The hologram generates a secure protection against counterfeiting, because of the state of the art technology and specialized equipment used for its production. In addition, it can be easily identified by any observer, without generating ambiguity, because of its three-dimensional aspect. For this reason the hologram has replaced traditional systems such as the watermark, intaglio printing, and the use of special inks or substrates, placing it on the cutting edge of protections against counterfeits and fraud.

The hologram is capable of creating true images in the third dimension (two-dimensional, three-dimensional, etc.), because it is capable of exactly recreating the light waves (interference pattern) that are reflected on a real object. All the characteristics of the light are engraved on plates of light-sensitive film using optic montages and a specific laser. There are 2D-3D holograms, color holograms, stereo holograms, micro text holograms, validations using a pointer-type laser, validation with a decoder, etc.

Holograms come printed on a wide variety of substrates. The most common is the self-adhesive label on various substrates such as paper, polyester, PVC, polypropylene, non-transferable materials, for manual or automatic application, and heat-transfer films for automatic application, making them applicable to any product regardless of the material, type of presentation or packaging used for the article protected.

The most commonly known form for the serial production of holograms is by applying heat and pressure on a metal sheet (with a holographic image on it) that is placed against a metallic plastic film, or covered with a transparent dielectric. This produces the holograms which are typically used to authenticate all kinds of products, and which are most representative of the holographic industry.

A 2D-3D hologram is prepared on two planes, one superficial and the other with depth, which are used to produce the sensation of a third dimension in rainbow colors.

Technological advances and permanently ongoing research for protections against counterfeiting have led to the realization of various classes of easily visible optical effects as well as other hidden or encrypted effects which can be seen only through the use of specific angles of light and with devices that are designed for this purpose.

These visible effects include the rainbow effect, three-dimensional effect, 2D/3D effect, color hologram effect, stereo hologram effect, or those obtained through a dot matrix master. Holograms have proven to amply comply with all security requirements to prevent counterfeits and fraud, as they are clearly visible in a wide range of lighting conditions.

To make or manufacture a hologram, the design or image desired is prepared with its corresponding security effects, and then used to create the holographic mold. The engraving plates are later generated using an electroforming process, and then assembled on the engraving equipment to generate the holographic films or materials with the desired width and depth. This means that any modifications required to the design initially approved will generate new costs to create the holographic molds and repeat the foregoing process, and therefore requires a significant investment in terms of time and resources.

Dot matrix holograms also support CLR (covert laser read) images, where a simple laser device can be used to verify the authenticity of the hologram. Processing images is a complicated mathematical task that involves solving large problems.

Variable holograms are the type of holograms where variable information is provided in the transparent coverings and produced by laser. For example a sequential alphanumeric numbering in holograms perceptibly increases security and facilitates follow-up of the material. The optic image includes variable information which cannot be removed without being destroyed. The variable information appears in the colors of the surfaces on which the hologram is placed.

U.S. Pat. No. 7,368,217 of May 6, 2008, entitled “Multi-Layer Image, particularly a multicolor image”, relates to a process for the production of a multi-layer image, preferably a multi-color image. A transfer film is used which is applied to a paper substrate and treated with laser irradiation. The transfer film has a laser-sensitive layer and a background layer arranged beneath it. The laser-sensitive layer includes for example laser-sensitive pigments or other laser-sensitive coloring agents. This results in an overlaying laser-induced image. As it is transparent or partly transparent, the background layer can have a printed image which becomes visible in that region. This therefore gives a multi-layer image which is formed by the laser-induced image component and by the background layer jointly where the variable text can be printed.

U.S. Pat. No. 7,672,030 and Mexican Patent 222,476 entitled “Process to reproduce images or texts on a metallic holographic film in all variation and colors, transparent oleographic two-dimensional or tridimensional oleographic” describe other types of holograms and their content is incorporated herein by reference.

### SUMMARY

This invention relates to all kinds of conventional and security holograms and the process by which they are produced, where the process allows the creation of individual serialized or personalized holograms by printing the design, image, drawing, serial number, word, or any other distinctive mark, on different substrates or papers, by applying a holographic film using heat and pressure on the substrate, so that upon removing the remaining film, the desired holographic image has only adhered on the design, image, drawing, serial number, words, or any other distinctive sign, printed on the substrate. This process allows the production of labels, stamps, forms, packages and similar items with holographic images that are variable in terms of design, alphanumeric characters, texts, drawings, or any other distinctive sign as well as in size, which holograms cannot be obtained by traditional means. The foregoing generates a unique product which is difficult or impossible to imitate, and of the highest security. It also allows the presence of elements for a fast and low-cost visual validation and inspection.

### DETAILED DESCRIPTION OF THE PREFERRED EMBODIMENTS

The holographic security labels object of this invention can be obtained through the following procedure:

A design, image, drawing, serial number, word, or any other distinctive sign, variable or serial, is prepared. This serial or variable image is printed on different substrates, cardboards, papers, and similar materials.

The design, image, drawing, serial number, words or any other distinctive sign, variable or serial, can be printed using flash fusion.

Flash fusion technology uses xenon lamps similar to those used as headlights for luxury automobiles. The printers used to make flash fusion prints contains flash lamps inside which are arranged in a specific design. The lamps are arranged in a row along the paper track inside the machine and sequentially emit light, exposing and melting the toner onto the substrate as it advances. In this way a micro-burst of light is used to heat the toner and not the substrate, resulting in a printed image which is better quality and more flexible. Flash fusion also eliminates the need for a teflon-type lubricant, thereby reducing the cost of consumables and environmental impacts. Flash fusion also provides spectacular improvements in terms of reliability and quality. As only the toner is heated and not the substrate, the latter maintains its humidity. In addition, substrate loss, deformation and static electricity are reduced to a minimum.

Once the printed substrate is obtained a holographic film is applied containing the holographic effects desired using a machine that applies heat and pressure, transferring only to the area where the design, image, drawing, serial number, words, or any other distinctive sign, variable or serial, are printed, which results in a series of products, each with a distinct and unique design, image, drawing, serial number, words, or any other distinctive sign. Application of the holographic film using heat and pressure to the area where the variable images are printed depends on the correct formulation of the adhesive, or the “sizing” of said holographic film, which must be according to the materials used (toner) for the variable print made using flash fusion technology. This guarantees the correct adhesion or anchoring to the substrates desired.

Dry adhesives (sizing) are available in different formulations that react to the application of a source of heat and pressure on the substrate. The most commonly used are the following: A) Sizing for adhesion to commercial papers, cardboards and similar materials; B) Sizing for adhesion to high security papers; C) Sizing for adhesion to synthetic materials such as PVC, polyester, and vinyl; D) Sizing for adhesion to natural materials such as leather and natural fibers for textile applications. The formulation of each sizing is laboratory developed using tests to adjust such factors as chemical composition, temperature and pressure to achieve adhesion on the different materials.

The process resulting from the aforementioned process is used to produce labels, stamps, forms, packaging, and similar articles, with variable holographic images (alphabet characters, numbers, alphanumeric, drawings, or any other distinctive sign) of any size which are practically impossible to reproduce or duplicate, due to the high technology involved in their production in terms of both machinery and equipment, as well as the skill, knowledge and experience required.

Labels, stamps, forms and packaging with variable holographic images can be used to prevent frauds, adulterations and counterfeits of official documents, securities, lottery tickets, certificates, tax stamps, diplomas, show tickets, identifications, insurance, and in general all kinds of items or official documents, as well as for the efficient administration and control of the applications.

The stamps, forms, packaging, and similar items with variable holographic images obtained using the process described create a great visual impact, attracting sustained attention for a time sufficient to transmit the messages and create a brand image in the mind of the consumer.

What is claimed is:

1. A process to manufacture high security variable holograms, wherein said process includes the following stages:
a) preparing a design, image, drawing, serial number, words or any other distinctive sign, variable or serial;
b) printing said serial or variable image on different substrates or paper;
c) once the substrate is printed, applying a holographic film containing the holographic effects desired using a machine that applies heat and pressure, transferring to the area where the design, image, drawing, serial number, words or any other distinctive sign, variable or serial, was printed; and
d) removing the remaining film that did not adhere to the design, image, drawing, serial number, words or any other distinctive sign printed on the substrate, allowing the formation of the holographic image desired.

2. The process according to claim 1, wherein the serial or variable image is printed on various substrates, cardboards, papers and similar substrates.

3. The process according to claim 1, wherein the design, image, drawing, serial number, words, or any other distinctive sign, variable or serial, is printed by flash fusion, in which the toner is heated and not the substrate.

4. A process according to claim 1, where in the adhesive or “sizing” used for said holographic film is appropriate for the materials used (toner) for the variable printing using flash fusion.

5. The process according to claim 1, wherein the adhesive is a dry adhesive or sizing which reacts to the application of a source of heat and pressure on the substrate and is selected from the group consisting of:
a) sizing for adhesion to commercial papers, cardboards and similar materials;
b) sizing for adhesion to high security papers;
c) sizing for adhesion to synthetic materials such as PVC, polyester and vinyl; and
d) sizing for adhesion to natural materials such as leather, and natural fibers for textile applications.

6. The process according to claim 1, wherein the printers making the print by flash fusion have flash lamps inside them which are arranged in a row along the paper track inside the machine, emitting light sequentially.

7. Labels, stamps, forms, packaging, and similar items with variable holographic images obtained through the procedure of claim 1.

8. The labels, stamps, forms, packaging, and similar items with variable holographic images according to claim 7, wherein each item is unique and different.

9. The use of the labels, stamps, forms, packaging and similar items with holographic images with variables according to claim 7, wherein they are applied to official documents, securities, lottery tickets, certificates, tax stamps, diplomas, show tickets, all kinds of identifications, insurances, and in general all kinds of official documents, as well as for the efficient administration and control of the application or solutions.
